(19) United States
(12) Patent Application Publication
(10) Pub. No.: US 2011/0122412 A1
(43) Pub. Date: May 26, 2011

(54) DEVICES AND METHODS FOR OPTICAL DETECTION

(75) Inventors: Chulmin Joo, Niskayuna, NY (US); Anthony John Murray, Lebanon, NJ (US); Masako Yamada, Niskayuna, NY (US)

(73) Assignee: GENERAL ELECTRIC COMPANY, SCHENECTADY, NY (US)

(21) Appl. No.: 12/623,714

(22) Filed: Nov. 23, 2009

(51) Int. Cl. G01J 3/45

(52) U.S. Cl. 356/451

(57) ABSTRACT

An optical detection system for sensing one or more samples is provided. The optical detection system comprises a broadband light source that emits a beam comprising a continuous spectrum over a range of wavelengths; a fluidic cell comprising one or more channels that positions the sample so that at least a portion of the beam is directed on the sample to produce a back reflected beam; and a spectrometer that analyzes an interference spectrum of the beam back reflected from the sample.

### BACKGROUND

The invention relates to optical detection, and more particularly to optical detection systems and methods for detecting the concentration, conformation and/or interaction among one or more types of molecules in a solution.

The area of miniaturized total analysis systems is driven by the need to analyze a large number of samples in a time efficient manner. Several detection techniques have the ability to perform rapid measurements on small amounts of analyte using chemical tags or functionalized surfaces. Many of such techniques include electrochemistry, mass-spectrometry, and optical detection techniques, such as Surface Plasmon Resonance (SPR) and interferometry. However, most of these techniques require extensive sample preparation such as surface activation, chemical tagging or labeling of molecules as a prerequisite for carrying out the detection. Sample preparation adds complexity to the measurement. Furthermore, detection on surfaces can complicate the extraction of kinetic binding data since the data can be influenced by transport kinetics.

For example, label-free sensing techniques, such as SPR and waveguide-based, which rely on surface sensitive refractive index sensing, are desirable because they do not require chemical tagging. Chemical tagging can introduce, and interfere with, molecule-molecule interactions, and is usually associated with spurious artifacts. SPR is an optical detection technique that also reduces analysis time. Although these techniques are extensively utilized to measure molecular binding on the surface, the required sensor surface activation and regeneration processes make these procedures time-consuming and may also add measurement-induced artifacts due to the interactions taking place on a surface, instead of in the bulk media. In addition, drawbacks of SPR include the necessity to use metal-plated substrates with carefully controlled coating thicknesses, as well as high quality optical prisms or gratings to couple the light into the surface layer under study.

Interferometry is among the most sensitive optical detection techniques known. Micro interferometric backscatter detection (MIBD) works on the principle that coherent light impinging on a cylindrically shaped capillary produces a highly modulated interference pattern. Typically, MIBD is based on interference of the laser light after it is reflected from different regions in a capillary. However, MIBD techniques are limited to detecting only one test sample at a given time. Therefore, if two or more test samples are to be measured, the detection cycle needs to be run separately for different species. For example, a reference sample and test sample cannot be measured simultaneously. Moreover, in MIBD the limit-of-detection is highly dependent on the exact measurement location of the projected fringes.

Therefore, it would be desirable to provide a simple, robust and sensitive optical detection technique that is able to simultaneously detect molecular conformational changes or interactions in two or more test samples.

### BRIEF DESCRIPTION

The invention relates to optical detection systems for measuring molecular composition, conformation or interaction by interferometric detection. Advantageously, the invention offers a label-free, surface-preparation free measurement methods for molecular composition, conformation or interaction. The systems and methods employ simple and robust geometry with simple and robust signal processing, and provide an ability to measure refractive index of two or more samples simultaneously. A “label-free” and “surface-preparation free” system not only reduces number of operations, but also reduces measurement artifacts by reducing complexity. The systems and methods allow the target molecules to be studied/analyzed in the natural state without additional labels or surface treatments. The interactions are in solution and the diffusion of the molecules is not influenced by diffusion to a surface.

Using a broadband light source enables the selection of the light source from a wide range of commercially available light sources. Also, the use of broadband light source enables simultaneous measurement of the buffer (reference) and sample solutions. For example different wavelengths from the broadband light source may be used for measurement of the buffer and sample solutions, thereby making the system efficient and less time consuming. Also, simultaneous measurement of the buffer and the sample solutions decreases the chance of any ambient disturbance effecting the measurement. For example, since the measurements for the buffer and the sample solutions are taken simultaneously, any ambient disturbance, such as vibrations, temperature change, or variations in the buffer that are present in the environment will be present for both the reference and the sample solutions, and hence, such variations/disturbances can be normalized or subtracted from the measurements of the sample solutions using the measurement of the buffer solution.

In one embodiment, an optical detection system for sensing one or more samples is provided. The optical detection system comprises a broadband light source that emits a beam comprising a continuous spectrum over a range of wavelengths; a fluidic cell comprising one or more channels that positions the sample so that at least a portion of the beam is directed on the sample to produce a back reflected beam; and a spectrometer that analyzes an interference spectrum of the beam back reflected from the sample.

In another embodiment, an optical detection system for analyzing a sample is provided. The optical detection system comprises a broadband light source that emits a beam comprising a continuous spectrum over a range of wavelength; a beam splitter that splits the beam into a first portion and a second portion; a fluidic cell that positions the sample so that at least a part of the first portion of the beam is directed onto the sample to produce a back reflected beam; and a spectrometer that analyzes an interference spectrum from the back reflected beam.

In yet another embodiment, a method for detecting molecular conformational changes or interactions in a sample is provided. The method comprises providing a broadband source that emits a beam comprising a continuous spectrum over a range of wavelengths; providing a fluidic cell comprising one or more channels; interacting the sample, introduced into the channel, with at least a portion of the beam and capturing a resultant back reflected beam; and analyzing an interference spectrum from the back reflected beam using a spectrometer.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic diagram of an embodiment of a system of the invention for optical detection of multiple samples;

FIGS. 2-5 are schematic diagrams of examples of molecular interaction assays in a fluidic cell of FIG. 1;

FIG. 6 is a schematic diagram of an example of a system for simultaneous optical detection of a sample at multiple locations in the flow path;

FIG. 7 is a schematic diagram of an example of a system for optical detection of multiple samples based on the size of the microfluidic channel in the fluidic cell;

FIG. 8 is a Fast Fourier Transform (FFT) conversion of an interference spectrum from the microfluidic channels of FIG. 5;

FIG. 9 is a flow chart of a method for optical detection of changes in the bulk refractive index of a solution;

FIG. 10 is a schematic diagram of another embodiment of a system of the invention for optical detection of changes in the solution resulting from changes in molecular composition, conformation or interaction;

FIG. 11 is a graph of measured phase changes caused by molecular interactions between bovine serum albumin (BSA) with anti-BSA and chicken lysozyme;

FIG. 12 is a schematic diagram of another embodiment of a system of the invention for optical detection of changes in the solution resulting from changes in molecular composition, conformation or interaction;

FIG. 13 is interference spectrum for a sample solution recorded at 1 Hz in the k-space;

FIG. 14 is a graph of the Fast Fourier Transform (FFT) of the graph in FIG. 11; and

FIG. 15 are graphs of the change in bulk refractive index over time and in the presence of increasing NaCl concentrations in a solution; and

FIG. 16 are graphs of the change in bulk refractive index over time and in the presence of increasing BSA concentrations in a solution.

### DETAILED DESCRIPTION

The invention enables measurement of molecular composition, conformation or interactions in the sample solution. The sample solution may have two or more number of molecules interacting within the channel, thus affecting the bulk refractive index. The invention enables simultaneous bulk refractive index measurements across several physical channels. For example, the refractive indices for reference sample and the test sample present in separate channels may be measured simultaneously.

To more clearly and concisely describe the subject matter of the claimed invention, the following definitions are provided for specific terms, which are used in the following description and the appended claims. Throughout the specification, exemplification of specific terms should be considered as non-limiting examples.

As used herein, the term “label free” means measurements that do not require chemical tagging of molecules for detection.

As used herein, the term “free solution” means detection that does not rely on a particular surface for analyte recognition.

As used herein, the term “broadband light source” refers to a light source that emits a continuous spectrum output over a range of wavelengths at any given point of time.

As used herein, the term “interference spectrum” refers to a plurality of light bands whose positions shift as a function of the refractive index of the solution.

In certain embodiments, the sample is illuminated at a determined (constant) angle, and a measurement is typically taken at another fixed angle. The measurement may be taken at 180 degrees angle relative to illumination, and in an “epi-detection” configuration where the illumination and detection are both normal to the sample surface. Fixed angles provide a singular interference node for refractive index measurement for a single sample, thereby avoiding any ambiguity of multiple interference nodes otherwise produced in measurements that rely on varying the angle of detection. Since the sample is irradiated at a single angle to take the measurement and a single angle is used for optical detection, the geometry of the system is simple and robust. In addition, data processing is simple and robust, as only one signal is read per sample as opposed to multiple nodes (each node corresponding to a particular angle) as in some MIBD systems. Further, the sensitivity of such multi-angle multi-node systems depends on which node is chosen for interpretation.

Advantageously, multiple samples can be read at once using either a (two-dimensional) 2-D spectrometer with same or different measurement channel diameters or a (one-dimensional) 1-D spectrometer with different measurement channel diameters.

The optical detection systems are suitable for proteomics applications where label free protein and DNA assays in free-solution are needed. The systems and methods of the invention may be employed for applications, such as but not limited to, binding changes, conformational changes, or dissociations and denaturing. In addition, the systems of the invention are also suitable as a detection device for capillary electrophoresis (CE), capillary electro-chromatography (CEC), flow injection analysis (FIA), physiometry, cell sorting or cell detection, changes in concentration of species in the sample solution, flow rate sensing and temperature sensing.

In various embodiments, one or more of bio-molecular interactions, protein-protein association or dissociation, multi-protein complex assembly or disassembly, DNA-DNA association or dissociation, molecular aggregation and separation, DNA/RNA-protein association and dissociation, protein or DNA denaturing and multi-protein competition assays may be measured using the system and method of the invention. Interactions may be affected by chemical or physical changes in one or more of the entities, induced by temperature, pH, phosphorylation, dephosphorylation, or other post-translational modifications, salts, enzymes, cofactors and other modifications.

In certain embodiments, the optical detection system comprises a broadband light source for emitting a beam, a fluidic cell for disposing a sample such that at least a portion of the beam is incident on a bulk of the sample to produce a back reflected beam, and a spectrometer for analyzing an interference spectrum formed by the back reflected beam from the sample. For example, a combination of two or more monochromatic lasers with discrete wavelengths is not a broadband light source, as such a combination will not have continuous wavelength. In one example, the spectrum is continuous over a wavelength range of about 10 nm.

In embodiments where the optical path for illumination of the sample and the optical path for detection of the interference spectrum coincide at least in some portions, the optical detection system employs a beam splitter. In these embodiments, the optical detection system comprises a broadband light source for emitting a beam, a beam splitter for splitting the beam in a first portion and a second portion, a fluidic cell for disposing a sample such that at least a part of the first portion of the beam is incident on the sample to produce a back reflected beam. The backscattered light comprises interference fringes resulting from the reflective and refractive interaction of the broadband light beam with the walls of the channels or the interfaces along the beam path and the sample. The system further comprises a spectrometer for analyzing the interference spectrum. The interference may be measured as a function of wavelength at the spectrometer. The fringe pattern or the interference pattern comprises a plurality of light bands whose positions shift as the refractive index of the solution is varied. The molecular composition, conformation or interaction changes in solutions corresponding to ions, atoms and/or molecules can be studied by analyzing the change in position of the light bands. The refractive index of the solution may vary due to one or more of compositional changes, conformational changes, and/or interactions between the same or different species of molecules.

The broadband light source enables the system to capture signatures of two or more test samples simultaneously using simple hardware. Conventional systems using monochromatic light are incapable of detecting two or more samples at the same time, and need to re-run the system to detect a second sample. Some of the advantages of the system over other systems include, but are not limited to, simpler hardware, unambiguous data processing, and easy implementation for simultaneous measurements of two or more samples, based on the different channel size with 1-D spectrometer or line detection with 2D spectrometer.

For molecular conformational and interaction measurements, more than one chemical species are introduced into the fluidic cell, mixed and passed through a channel, such as microfluidic channel, into a detection area inside the fluidic channel, where the flow is stopped. The change of the interference spectrum may be measured as a function of time. In one example, the conformational changes of the species subsequent to the molecular interactions lead to a change in the bulk refractive index, and hence the change in the spectrum of the interference signal.

In certain embodiments, the system is configured for in-line detection of a molecular interaction where the flow is not stopped. In these embodiments, the channel may be observed at multiple points down stream of mixing to observe the change in the refractive index at multiple times following mixing. By avoiding the use of a stopped flow arrangement, the system can be used for in-line monitoring such as, but not limited to, monitoring eluting species in a separation technique. Also, in one embodiment, the system can provide a reference measurement, which is either upstream or downstream relative to the sampling point. In such an embodiment, both the reference and sample measurements are taken downstream of the mixing region. In this way, a signal specific to the binding of molecules can be extracted, rather than a signal that is due to simple concentration increase.

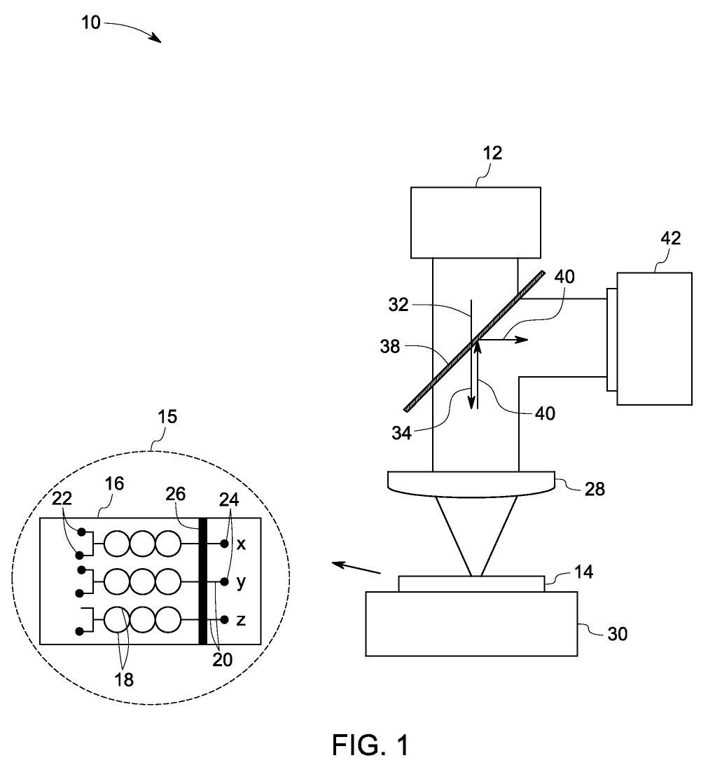

FIG. 1 illustrates an optical detection system 10 having a broadband light source 12. The broadband light source 12 may include a light emitting diode, super-luminescent laser diode (SLD), incandescent white light sources (such as, tungsten, xenon, halogen), solid-state lasers, or tapered amplifier. In one embodiment, the spectral bandwidth of the broadband light source 12 is greater than about 10 nm. The system 10 may be used for bulk or volume refractive index measurement of multiple samples.

The beam may be directed to the fluidic cell or flow cell 14 by a fiber (for example, a single mode fiber). The fiber transmits broadband light beam from the light source to the fluidic cell 14. Alternately, the beam may be directed to the fluidic cell 14 by free space transmission.

Enlarged top view of the fluidic cell 14 is illustrated in the dashed circle 15. The flow cell 14 may be disposed on a substrate 16. The substrate 16 may be made of silicon, glass, or plastic (for example, polydimethylsiloxane (PDMS)). In one example, the substrate 16 may be a microfluidic chip, for example. The measurement channels 20 may include a flow channel, a microfluidic channel, or a capillary tube. The flow cell 14 comprises mixing channels 18 and measurement channels 20. The number of mixing channels 18 and measurement channels 20 in the fluidic cell 14 may depend on the number of samples to be detected and ease of fabrication of the fluidic cell 14 with the desired number of mixing channels 18 and the measurement channels 20. Each of the measurement channels 20 extends into the plane of the paper. Inlet and outlet for the sample solutions in the measurement channels 20 are represented by reference numerals 22 and 24, respectively. The sample solutions and the reference may be a liquid, a gas or a solid. The sample solutions may be mixed in the mixing channels 18 and passed in the measurement channels 20. The solution may be either flowing or stationary inside the fluidic cell 14.

The measurement channels 20 may have a circular cross-section, rectangular cross-section, or any other geometric shape. The dimensions of the measurement channels 20 can be varied over a wide range, and are limited primarily by the spectral resolution of the spectrometer and the width of the incident beam. In one embodiment, the beam width is about 5 percent to about 10 percent larger than the width of the channel. The measurement channels 20 may have appropriate dimensions to enable detection of desired sample solutions. In certain embodiments, the fluidic channel 14 may employ two or more different channels 20 (such as capillary tubes), having different diameters. The channels 20 with different diameters may be used to detect samples with different chemical or composition. The interference of light reflected from the channels 20 having different sizes leads to interference fringes with different frequency components. By taking Fast Fourier Transform (FFT), the interference signal corresponding to each channel can be differentiated, and the phase, or shift of the interference fringes with different frequency component can be quantified. Such measurements can be done by using either a 2-D spectrometer, or a 1-D spectrometer.

Each of the rows represented by letters x, y and z may have different samples. For example, microfluidic channel 20 of row x may have a reference sample (such as a buffer), and rows y and z may have sample solutions for measuring bulk or volume refractive indices. The measurement channel 20 having the reference sample may provide a reference signal. The reference measurement channel may be filled with a buffer solution. The reference channel helps improve the accuracy of the measurements. For example, the reference signal compensates for undesired environmental changes, such as temperature changes, within the channel. The reference channel and the channel having the sample solution (that is to be analyzed) may be disposed in close proximity to each other and illuminated either simultaneously or sequentially. By monitoring position changes for both of the resulting fringe patterns, it is possible to discriminate between the desired refractive index signal generated by the sample and the background noise, thereby resulting in improved signal to noise ratio (SNR). The background interferences may be produced by the flow of the sample or environmental perturbations, such as temperature and/or pressure changes. Measuring the reference channel simultaneously with the test channel (instead of serially, as in the MIBD case) allows time-dependent background noises to be normalized in real time.

The measurement channels 20 may be illuminated by a single scan line 26. Illumination of the channels 20 by the single scan line 26 allows simultaneous detection of multiple reactions that occur in the different channels 20. Optics may be used to focus, collimate, and/or direct the beam to the fluidic cell 14. In one example, a cylindrical lens 28 may be employed before the fluidic cell 14 to focus the beam onto the fluidic cell 14.

The measurement channels 20 may have a detection zone through which the sample solution may be continuously monitored while flowing through the zone to observe changes in the contents of the sample over time. These changes may include, for example, the presence of cells. In one embodiment, the outlet 24 of the measurement channels 20 may be diverted to another measurement channel, for example, to sort the cells according to refractive index measurements.

As refractive index and molecular interactions are highly dependent on temperature, inadvertent thermal fluctuations must be contained to prevent thermal fluctuations adding to measurement noise. This can be achieved by physically insulating the apparatus against changes in ambient temperature, as well as employing active thermal control. In certain embodiments, the fluidic cell 14 is configured to undergo temperature change. For example, the fluidic cell 14 is thermally controlled to modulate molecular interaction inside the fluidic cell 14, as in the case of DNA interactions. A temperature control device 30, such as a heater, or a cooler (such as Peltier cooler) may be used along with a temperature measuring device and a dynamic feedback loop (not shown). In another example, a solution containing already-bound DNA could be injected simultaneously with a buffer-only solution and mixed, wherein the subsequent dissociation or denaturing can be monitored as one or more of temperature, pH or salt concentration of the buffer are varied.

Although not illustrated, the system 10 may employ additional optics, such as but not limited to, a collimator, focusing lens, or mirror. For example, in addition to the cylindrical lens 28, a collimator may be situated before the entry of the fluidic cell 14 to collimate the beam before the beam enters the fluidic cell 14. A focusing lens may be situated at the exit or at a distance from the exit of the fluidic cell 14 to collect all the exiting radiation; the collected radiation may be focused on to a mirror and reflected back in the fiber.

Reference numeral 32 represents a beam of light travelling from the broadband light source 12 to the fluidic cell 14. The beam 32 is split into two portions using a beam splitter 38. In one example, the beam-splitter 38 may include a 2×2 fiber coupler or free-space beam-splitter.

The transmitted portion 34 impinges on a sample placed in the fluidic cell 14. The portion 34 impinges on the sample at a fixed angle. This impingement angle may be perpendicular to the sample or it may be off-axis from the sample. The broadband architecture is robust to small deviations in alignment. A part of the beam portion 34 is back reflected (represented by reference numeral 40) after interacting with the sample disposed in the fluidic cell 14. The back reflected beam 40 produces an interference spectrum. The interference spectrum comprises alternatingly disposed light and dark fringes that are spatially separated.

The interference spectrum is analyzed by the spectrometer 42 to determine the refractive index of the sample. In one embodiment, the spectrometer is a 2-D spectrometer. The 2-D spectrometer may include a 2-D array of suitable resolution. For each of the channels x, y and z in the fluidic cell 14 there is a corresponding column or row in the 2-D spectrometer to measure the interference fringe of the corresponding channel of the fluidic cell 14. By quantifying the shift of the interference fringes, the refractive index changes or molecular interactions in each channel 20 can be measured. In another embodiment, the spectrometer 42 is a 1-D spectrometer. By using multiple channels with different channel diameters, multiple peaks are projected onto the 1-D spectrometer, each corresponding to a different channel. By quantifying the shift of each of these peaks, the conformational changes or molecular interactions in each channel can be measured. The spectrometer 42 may be coupled to a data processor for receiving measurements of light intensity from the spectrometer and for conducting analysis thereon, wherein the analysis comprises determining a parameter of an interference spectrum. Non-limiting examples of such parameters may include frequency, phase, and intensity of the interference fringes. The parameters may then be used to determine the refractive index of the solution.

The measured refractive index may be indicative of various properties of the sample including the presence or concentration of a solute substance, for example, interaction of molecules that are either identical (aggregation) or not identical (binding). Non-limiting examples of properties include conformational change, pressure, pH, temperature or flow rate (e.g. by determining when a thermal perturbation in a liquid flow reaches a spectrometer).

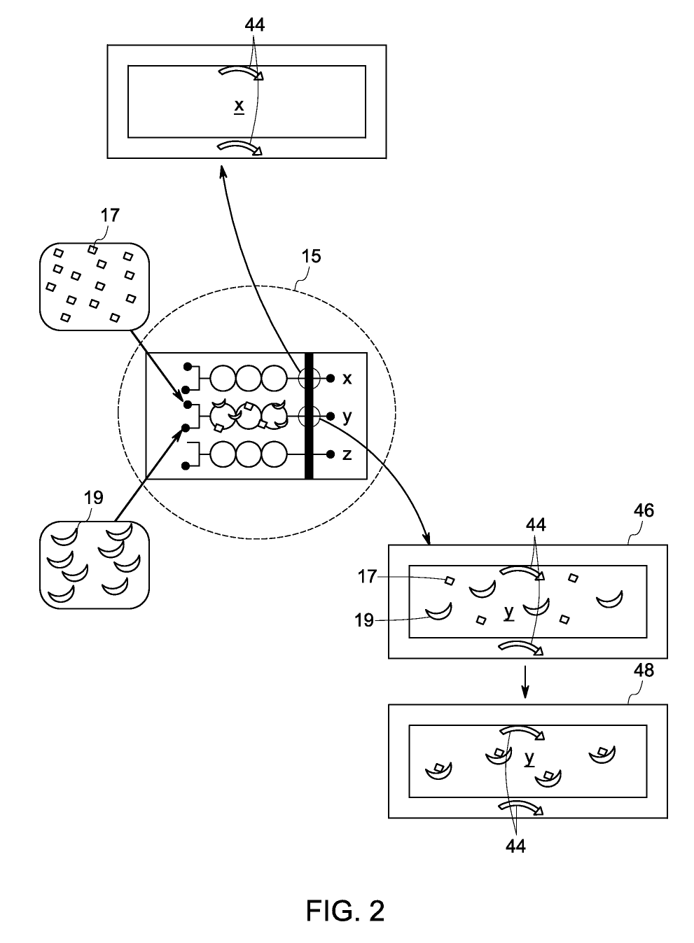

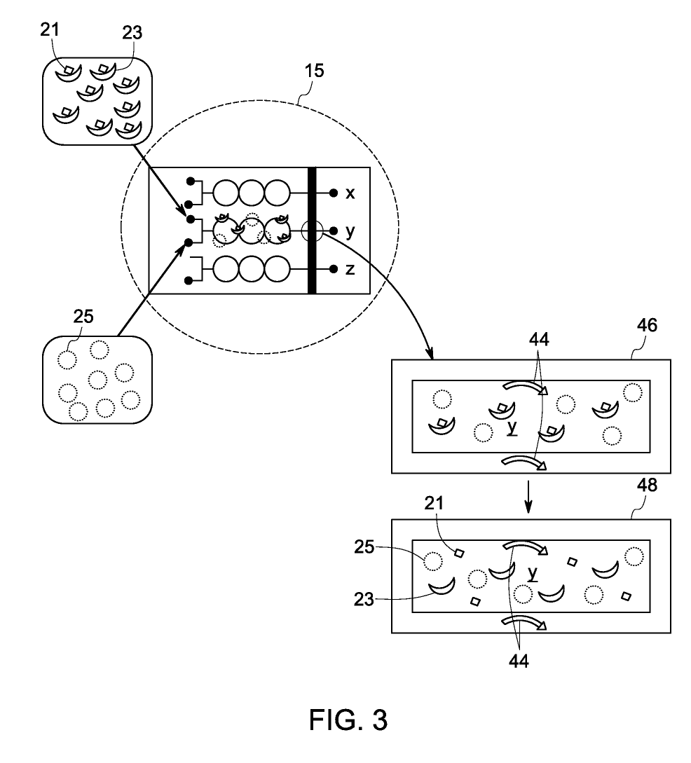

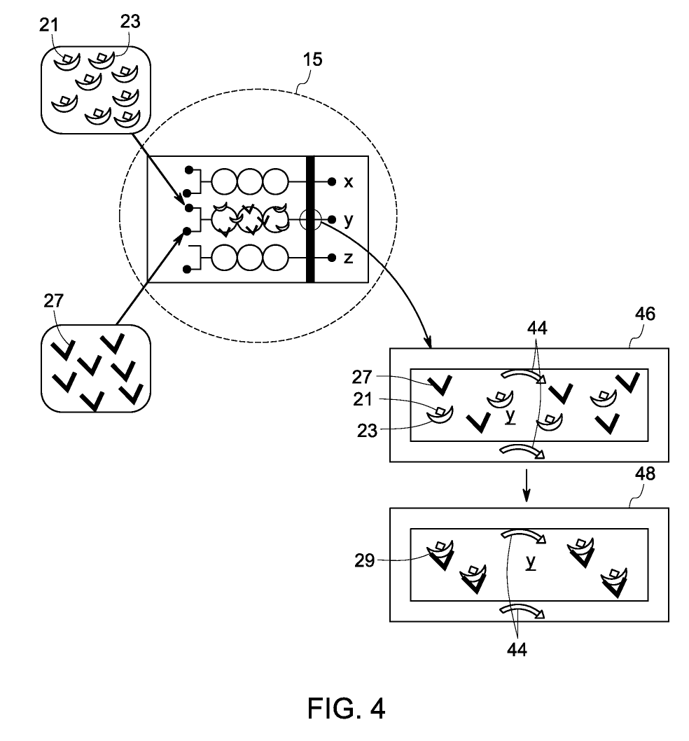

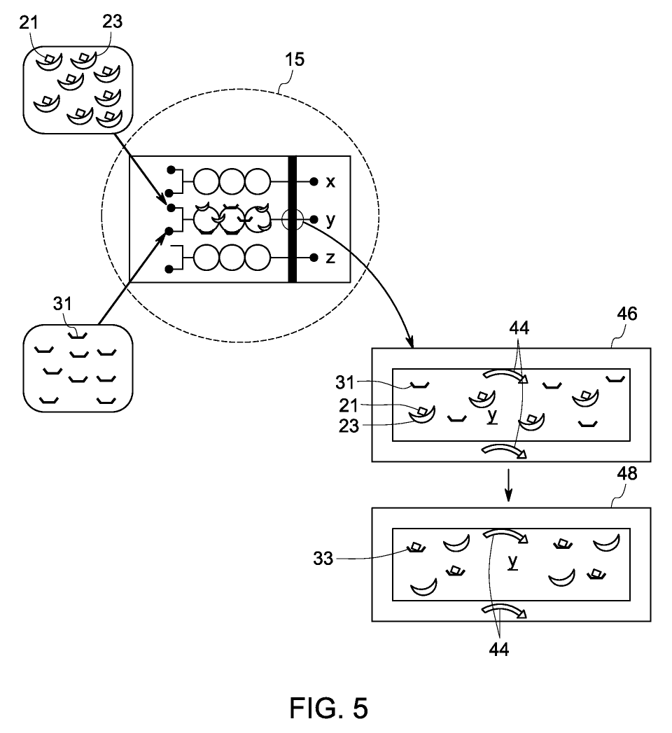

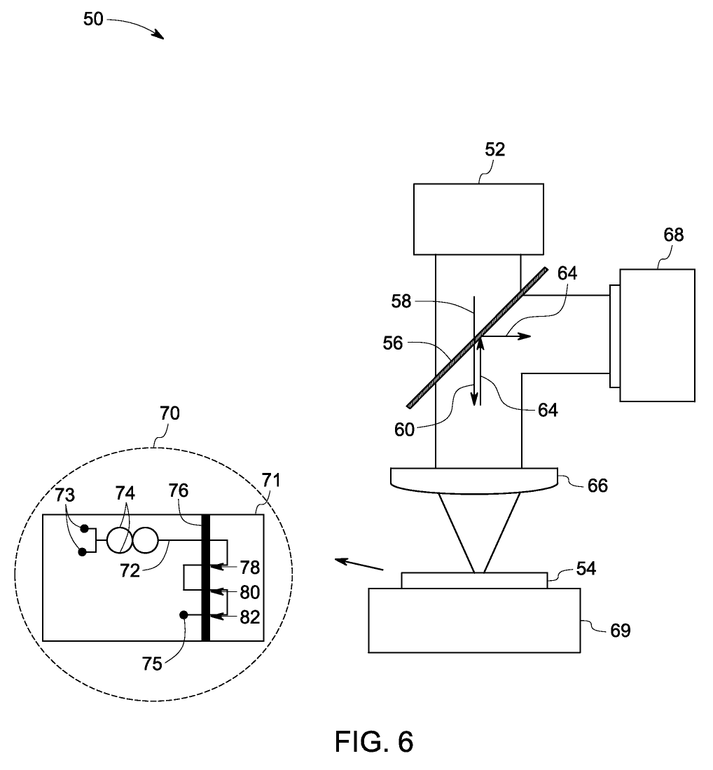

FIG. 2 illustrates an example of interactions taking place in the flow paths (such as channels 20 of FIG. 1). The invention enables the use of bulk or volume refractive index measurements to measure such interactions. The bulk refractive index measurements allow more flexibility for system design, and require less sample preparation time. The geometry also more closely resembles natural interactions. For example, the bulk refractive index measurements do not require a surface with binding moieties to be present in the channels 20 for binding target molecules. A line scan 26 (FIG. 1) performed at a given time simultaneously provides individual information on bulk refractive indices for the three sample solutions (one of which can be reference) present in the three rows x, y and z of the channels 20. Several line scans may be performed at different time intervals to study the interaction of the two molecules over time. In one example where the row x contains buffer solution, the refractive index measurement may not change with time. The sample solution in row y may be a mixture of two different molecular species 17 and 19. The solution containing the two molecular species may be mixed (arrows 44) inside the channel 20. FIG. 3 illustrates an example of dissociation or denaturing in the flow paths (such as channels 20 of FIG. 1). The dissociation or denaturing of the molecular species 21 and 23 can be monitored by varying one or more of a temperature, pH or salt concentration of the buffer 25. FIG. 4 illustrates an example of multi-protein complex assembly. The molecular species 21 and 23 form a complex 31 with the protein 27. FIG. 6 illustrates an example of multi-protein competition assay, where the proteins 21 and 23 that are initially bind together, dissociate in the presence of protein 29. Proteins 23 and 29 compete to bind with the protein 21 to form a complex. In the illustrated example, protein 21 and 29 bind to form a complex 33. The change in the interference spectrum, such as the shift in the position of the FFT peak for the corresponding channel, is an indicator of the amount of binding or dissociation. As the mixing increases and molecules bind to each other or dissociate from each other from time t₁ (46) to t₂ (48), the FFT peak for the corresponding row y of channels shifts in the FFT.

FIG. 6 illustrates an example of a system for in-line process monitoring where flow is not stopped for measuring bulk refractive indices of the sample solution contained in the channels of the system. The system 50 comprises a broadband light source 52 for illuminating the sample placed in the fluidic cell 54. A beam splitter 56 is used for splitting the beam of light 58 into two portions. The transmitted portion 60 is used to illuminate the sample disposed in the fluidic cell 54. Beam 64 back-reflected from the sample is detected by the spectrometer 68. A cylindrical lens 66 is used to focus the beam 60 in a line onto the sample disposed in the fluidic cell 54. The fluidic cell 54 may be temperature controlled using the temperature control device 69.

The design of the fluidic cell 54 is illustrated in an enlarged view represented by dashed circle 70. The fluidic cell 54 comprises a substrate 71, microfluidic channels 72, and mixing channels 74. The sample to be detected is disposed in the microfluidic channels 72 using inlets 73, the sample flows through the channels 72 before exiting the fluidic cell 54 through the outlet 75. Several positions along the flow path 72 may be monitored to determine the change in refractive index along the flow path 72. The change in the refractive index of the sample may be due to compositional, conformational or interaction changes of the species present in the channels 72. Depending on the shape of the flow path 72, a line scan 76 performed at a given instance may provide information about a plurality of locations. In the illustrated example, the line scan 76 provides information for four different locations in the flow path 74. In the illustrated example, three locations 78, 80 and 82 are used for measurement purposes. Such measurements are not feasible in surface dependent measurement systems (such as SPR), as the binding activity would not steadily progress along the flow path, as in the case of the invention. In effect, by illuminating multiple locations along the flow path, the line scans takes measurements at different time intervals and adds the dimension of time and kinetics to the measurement of the bulk refractive index.

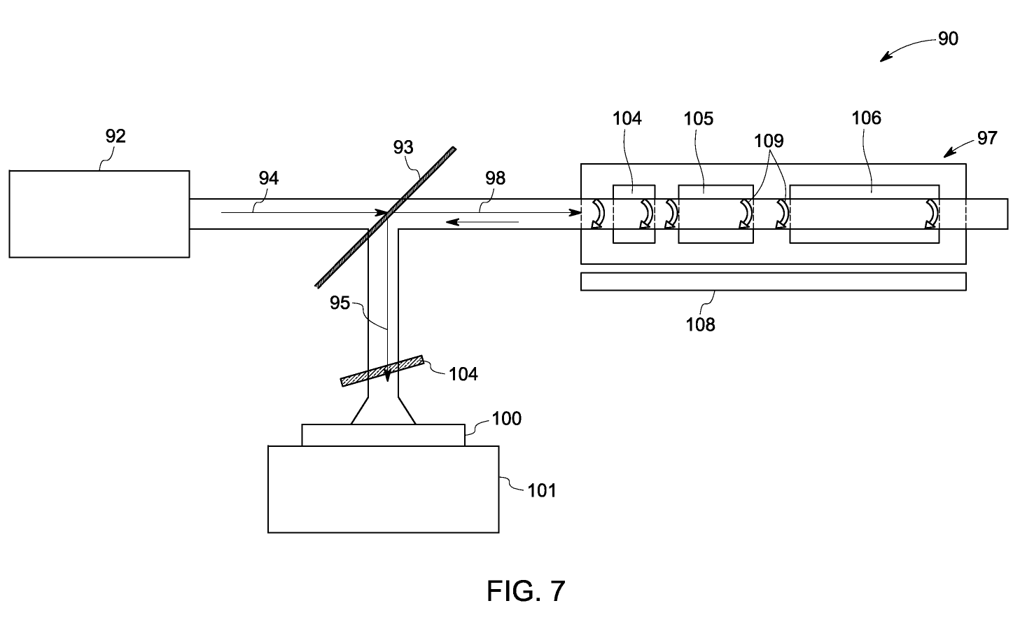

FIG. 7 illustrates an optical detection system 90 employing a 1-D detector for analyzing the interference spectrum of bulk refractive index measurements. A broadband light source 92 produces a beam 94. A portion 98 of the beam 94 is directed towards a sample using a beam splitter 93. The sample is placed in a sample holder or a fluidic cell 97. The back-reflected light 95 is detected by a spectrometer composed of grating 104 and line scan camera 100.

The sample holder 97 employs measurement channels 104, 105 and 106 of different sizes. The sample holder 97 may employ as many number of measurement channels as required, or as feasible by the fabrication processes. As represented by the arrows 109, the sample solutions may be mixed in the channels 104, 105 and 106. In the illustrated embodiment, the channels 104, 105 and 106 are shown as being progressively larger in size, however, it should be noted that any other possible distribution of sizes of the channels is also envisioned within the scope of the invention. A temperature control device 108 may be employed to control the temperature of the individual channels 104, 105 and 106.

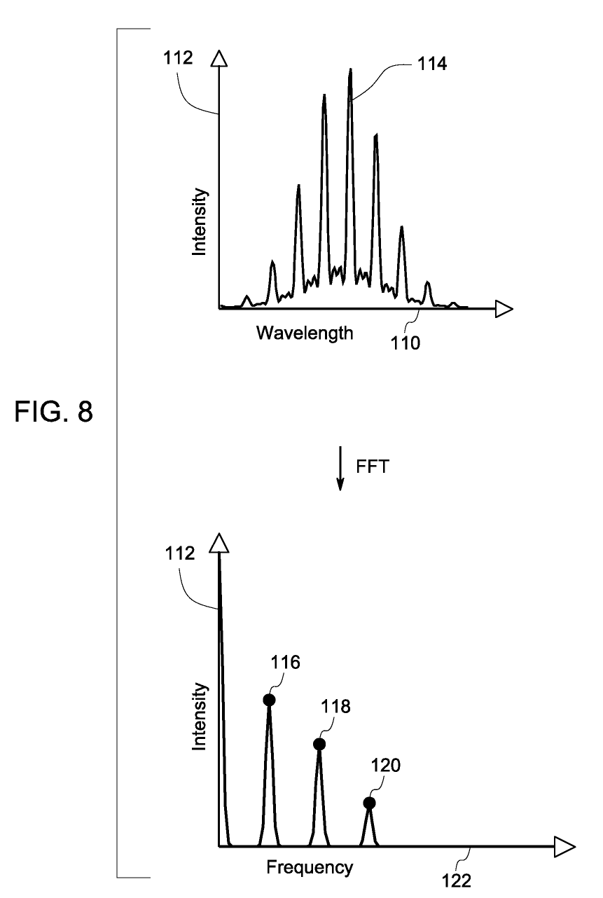

As illustrated in FIG. 8, the measurement of the three measurement channels 104, 105 and 106 (FIG. 7) can be taken simultaneously; the intensity (ordinate 112) of the back-reflected light may be plotted as a function of the wavelength (abscissa 110) as illustrated by the graph 114. The interference of light reflected from the channels 104, 105 and 106 of different sizes results in different frequency components in the interference spectrum 114. The graph 114 may be transformed using FFT to clearly represent the peaks 116, 118 and 120 corresponding to the different channels 104, 105 and 106, respectively. The abscissa 122 represents the frequency. By using the FFT, the interference signal corresponding to each of the channel can be differentiated and measured individually.

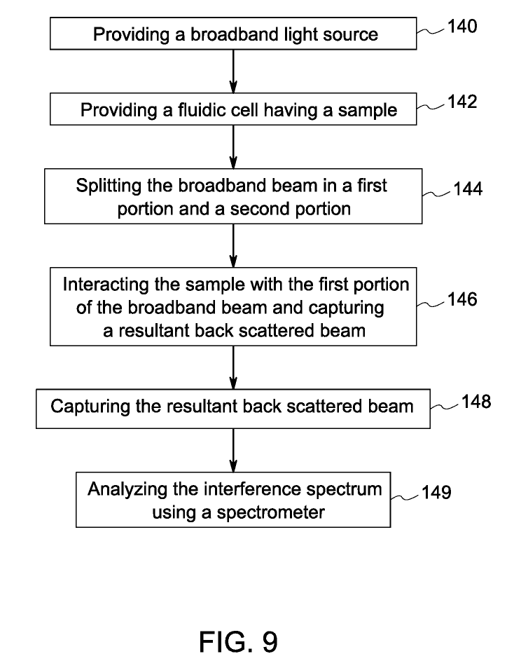

FIG. 9 is a flow chart for an example of a method of the invention for detecting refractive indices. At block 140, a broadband light source is provided. The broadband light source provides a beam. At block 142, a fluidic cell having one or more types of molecules inside a channel is provided. In one example, the fluidic cell comprises at least two different channels. In embodiments where a reference solution is used, the sample channel receives the sample to undergo reaction/change that is to be monitored, while the reference channel receives a reference sample that would only be exposed to effects of background interference. By monitoring position changes for both of the resulting fringe patterns, it is possible to discriminate between the desired refractive index signal generated by the sample and the background interference caused by factors such as temperature drift, ambient vibrations and fluctuations in buffer. Two molecules, either different or of the same type, are introduced into the fluidic cell and mixed in the mixing region and then analyzed for binding as a function of time. In one example, the fluid flow is stopped in one or more channels and multiple reactions can be monitored simultaneously. In another example, interference spectra from two or more locations in the fluidic cell are analyzed without stopping the flow.

At block 144, the beam from the light source is split into two or more portions. At block 146, the first portion is directed on the solution in the channel inside the fluidic cell. The first portion of the beam interacts with the volume of the sample in the fluidic cell.

Light in the sample arm of the fluidic cell is reflected by the interfaces along the beam path, and spectral detection of the interference allows the corresponding interference signal to be resolved. The phase of the interference between reflections from the two opposing surfaces of fluidic cell is measured. The phase due to the change of refractive index of the medium is given by Equation 1.

Δφ=2k₀LΔn Equation 1

where k₀ is the wave number at the center wavelength, L is the path-length (for example, 100 μm), and Δn is the RI change. In one example, the phase fluctuation is measured with air inside the cell to determine the limit-of-detection given by Equation 2.

$$δ n = \frac{δ φ}{2 {k}_{0} L} . \qquad Equation 2$$

At block 148, a resultant back-scattered beam is captured. In addition, if a mirror is employed after the fluidic cell, the light is reflected by the mirror, and re-coupled into the fiber. In one example, 70 percent of the beam is directed to the spectrometer to measure the interference pattern. In one embodiment, the back-scattered beam is detected over a range of angles.

At block 149, the interference spectrum is analyzed using a spectrometer. In one example, the interference spectrum is analyzed at a frequency in a range from about 1 Hz to about 1 MHz, determined by the readout rate of the spectrometer. Optionally, a reference signal may be applied from the reference channel, to compensate for the background interference.

### Example 1

A spectral interferometric bulk refractive index sensor is assembled using the components described below:

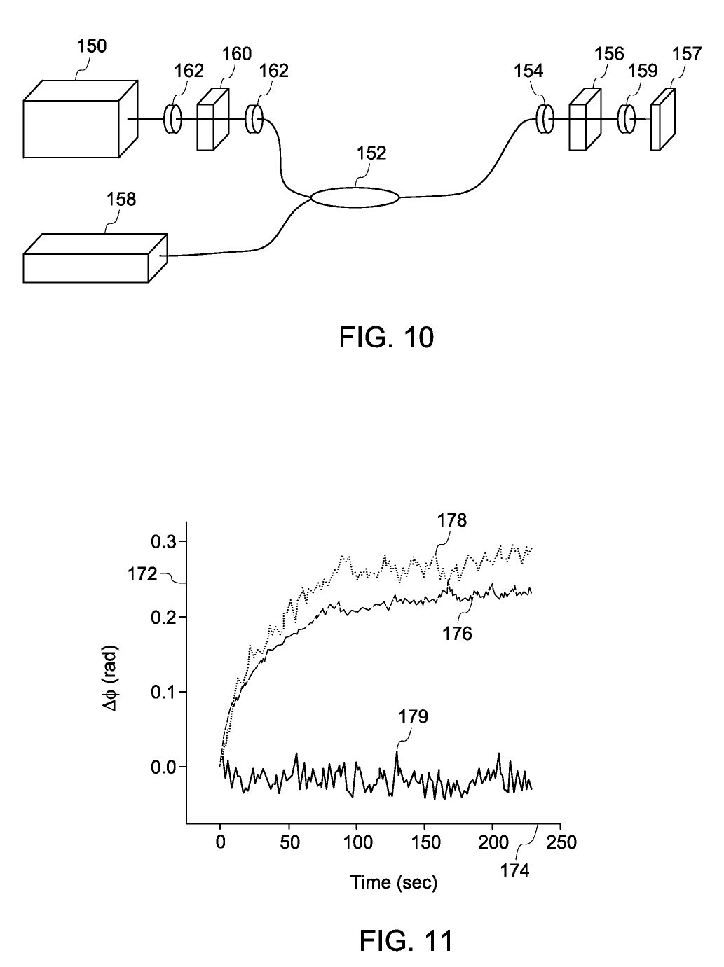

As illustrated in FIG. 10, one of the two light sources: 150 (1) Covega (SLD-1021, λ₀˜1030 nm/Δλ˜60 nm), (2) or Superlum (SLD-1021, λ₀˜840 nm/Δλ˜50 nm) superluminiscent laser diode (SLD) along with SLD mount/driver is employed as a broadband light source. Fiber beam-splitter 152 is a single-mode 2×2 fiber coupler (AC-Photonics, Inc.). Collimator 154 is a fiberport for FC/APC, (PAF-X-15). Fluidic cell 156 has a path-length of 100 μm and was acquired from Starna Cells, Inc., 48-Q-0.1, and spectrometer 158 is a USB 4000, manufactured by Ocean Optics.

All the components are mounted on a 12″×18″ optical breadboard. Light from the SLD 150 is collimated and passed through an isolator 160, and lens 162. The isolator 160 is used to avoid back-reflection into the SLD 150. The back-reflection may cause lower output power, and can damage SLD 150. The light is then coupled into a fiber coupler 152, and one arm is directed to the probe. In the probe, the fluidic cell 156 is configured for refractive index measurement. A mirror 157 and a focusing lens 159 are disposed such that the reflected light from the probe is re-coupled into the fiber. Fifty percent of the re-coupled light is directed to the spectrometer 158 to measure the interference spectrum.

### Example 2

### Spectral Interferometric Bulk RI Sensor for Micro-Capillary Tubes

The molecular interaction sensor of Example 1 is further configured for free-solution molecular interaction sensing by integrating a temperature controlling system and flexible square type silica tubes. Two protein solutions were injected into the micro-tubes at ˜12 μL/min using a peristaltic pump (obtained from Harvard Apparatus, 11plus). The solutions were then mixed together by a T-connector (obtained from IDEX Health & Science, Corp.), and passed through a square flexible fused silica micro-capillary tube (obtained from Polymicro Technologies, AZ). The probe beam from a broadband light source (SLD-371-HP2-DBUT-SM-PD-FC/APC, manufactured by SUPERLUM, Ireland) was positioned at about 15 cm downstream from the exit of the T-connector, and the back-reflected light from the tube was collected and measured with a spectrometer (USB4000, manufactured by Ocean Optics). For measurement purposes, the flow was stopped, and phase changes in the interference spectrum were measured as a function of time.

FIG. 11 is a graph of phase change (ordinate 172) as a function of time (abscissa 174). Graphs 176 and 178 represents the interactions between bovine serum albumin (BSA) and anti-BSA (a-BSA) at different concentrations of BSA and a-BSA. Graph 176 represents BSA (5 μmol/L) and a-BSA (15 μmol/L), and graph 178 represents BSA (7 μmol/L) and a-BSA (15 μmol/L), which shows a clear difference before and after the interaction.

Interactions between BSA and a-BSA induced remarkable changes in phase. However, as illustrated by graph 179, no significant change was measured for the control experiment that was performed with chicken lysozyme (14 nmol/L) and BSA (100 nmol/L). The high noise in the measurement may be attributed to undesired effects such as vibrations, temperature fluctuations and fluctuations in the buffer.

### Example 3

### Measurement of Dynamic Refractive Index Change

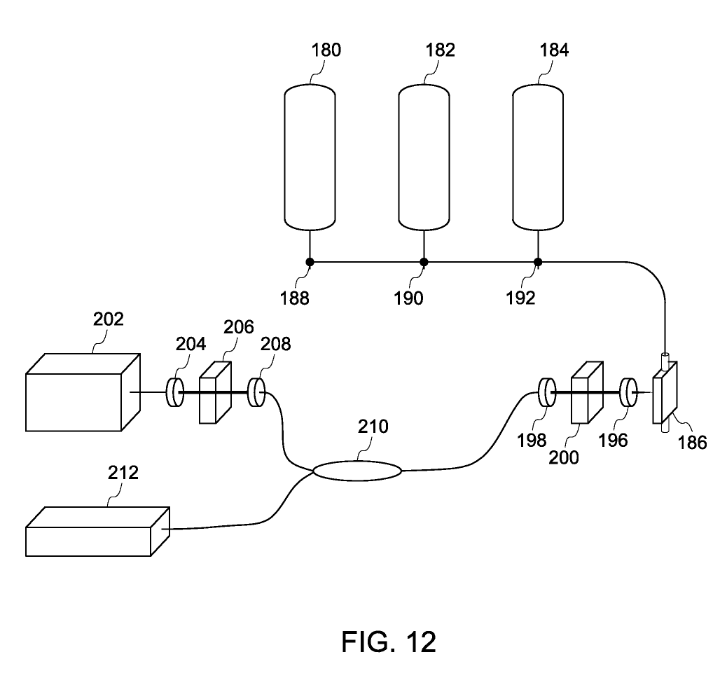

An experimental design for measurement of dynamic refractive index change is illustrated in FIG. 12. Three sample containers 180, 182, and 184 are used to hold sample solutions. The flow rate of the sample from the sample containers 180, 182, and 184 into the flow cell 186 is controlled by using the valves 188, 190 and 192. The flow cell 186 has an inner flow channel (not shown) with a depth of 100 microns. The interference spectrum of the reflections is measured from the top and bottom surfaces of the measurement channels of the flow cell 186.

The flow cell 186 (Starna Cells, 48-Q-0.1) has transparent glass windows (not shown) along the beam path and the measurement channel (not shown) has a depth of 100 microns. The set up further includes a focusing lens 196, collimator 198, and a filter 200.

The beam from the light source 202 is focused using the focusing lens 204 and passed through the isolator 206 and then through the collimator 208. Further, a beam splitter 210 is employed to split the beam into 50:50 portions.

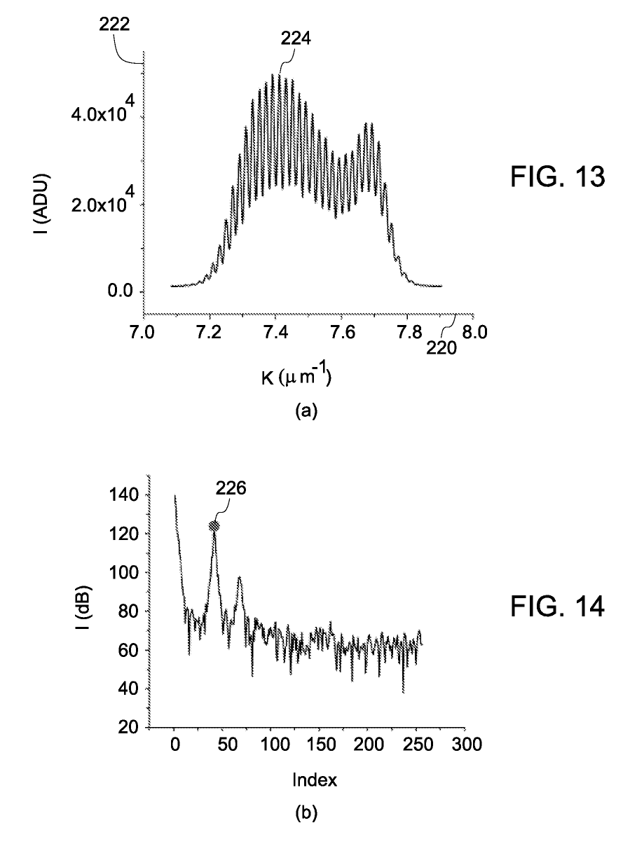

Spectrometer 212 measures the interference signal between the reflections from the top and bottom of the microfluidic channels interfaces inside the channel to detect the refractive index change inside the channel. With de-ionized water inside the channel, the measured interference spectrum is shown in FIG. 13, where phase change 222 is plotted as a function of coefficient k 220. The fringes 224 result from the interference of the reflections from the interfaces along the beam path. The FFT of the interference signal is shown in FIG. 14, and the signal of interest, which is the interference between top and bottom interfaces inside the channel, is indicated with reference numeral 226.

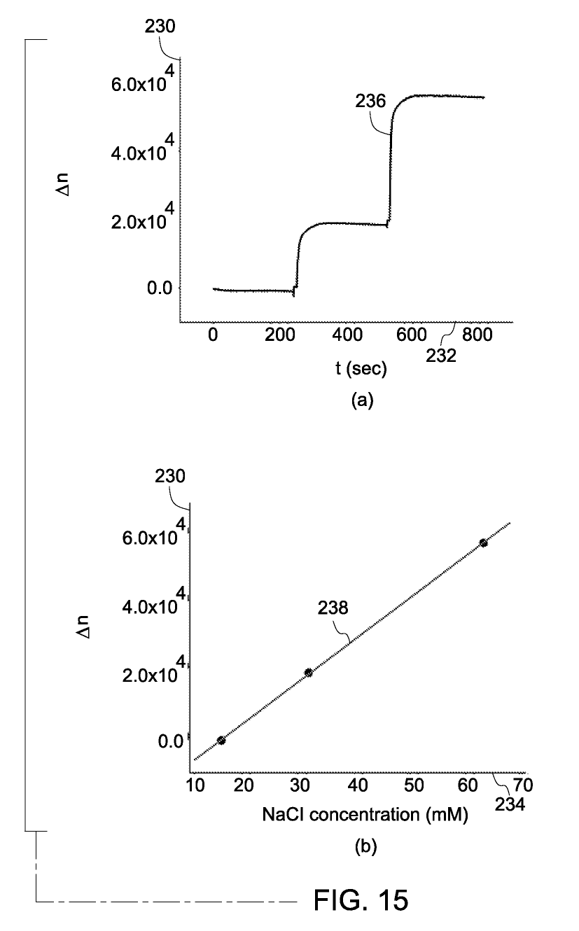

FIG. 15 is a graph showing the change in bulk refractive index (ordinate 230) over time (abscissa 232) in the presence of increasing NaCl concentration (abscissa 234) in a solution, as represented by curves 236 and 238, respectively. NaCl solutions with different concentrations are used as samples. 5 M NaCl stock solution is diluted with de-ionized water to obtain about 15.6 mM, 31.2 mM, and 62.5 mM NaCl solutions. The solutions flow into the channel from the lowest to the highest, and interference spectrum is acquired at 1 Hz. The phase information of the interference signal of interest is examined, and the measured phase change is converted into refractive index change through the relationship represented by Equation 3.

Δn=Δφ/2k₀t Equation 3

where Δn is the refractive index change, Δφ is the measured phase change, k₀ is the center wave-number defined by 2π/λ₀ with center wavelength λ₀, (840 nm in our case), t is the channel depth (100 μm in the current design), respectively. The refractive index value at the steady-state region for each concentration is averaged, and the average refractive index change is evaluated as a function of NaCl concentration. The linear fit, corresponding to sensitivity, has a slope of 1.25×10⁻⁵ (RI/mM). The limit of detection of the system was measured as 1.5×10⁻⁷ RIU. Sensitivity is dependent on the design of the apparatus, whereas limit of detection is dependent on the amount of system noise and the ability to resolve small changes in signal.

### Example 4

### Refractive Index Change as a Function of Macromolecule Concentration

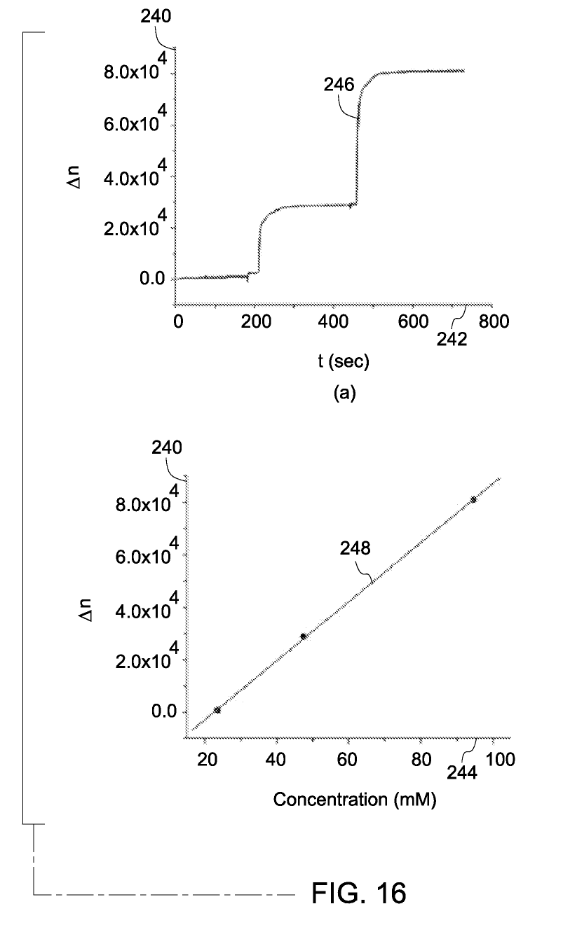

The arrangement described in Example 2 is used to carry out dynamic refractive index change measurements with Bovine Serum Albumin (BSA) solution. 5 percent BSA stock solution (50 g/L) is diluted to obtain about 23.7, 47.4, and 94.7 μM BSA solution. The solutions with different concentrations flow into the measurement flow cell sequentially. FIG. 16 shows the refractive index change (ordinate 240) as a function of time (abscissa 242), and change in along with refractive index (ordinate 240) versus BSA concentration (abscissa 244). The linear fit 248 to the curve 246 has a slope or sensitivity of about 1.125×10⁻⁸ RIU/nM.

The systems and methods of the invention may be adapted to use molecular interaction as an on-line analytical tool. For example, as an interaction sensor, it is possible to monitor the elution profile of a molecule of interest during a separation process, by continuously mixing with effluent from the separation process and measuring at one or more sampling points (corresponding to delay times) downstream of the mixing point. Such monitoring of elution profile is otherwise difficult using conventional SPR with surface bound molecules because the surface(s) would need constant regeneration. The specificity is a function of binding to a suitable second molecule

The optical detection system does not require labeling unlike other fluorescent and radioactive marker based approaches. Moreover, users do not need to use complicated surface chemistry to functionalize and clean the sensor surface. If non-specific binding to the glass needs to be specifically avoided, the channel may be treated to minimize the effect. The experimental design is simple, easy to build, and can be configured for simultaneous detection of two or more samples by using 2-D detector or by using a 1-D detector with multiple diameter channels. The system may be used to analyze a molecular reaction/interaction conducted on a “lab on a chip” type device.

While only certain features of the invention have been illustrated and described herein, many modifications and changes will occur to those skilled in the art. It is, therefore, to be understood that the appended claims are intended to cover all such modifications and changes as fall within the scope of the invention.

1. An optical detection system for sensing one or more samples, comprising:
a broadband light source that emits a beam comprising a continuous spectrum over a range of wavelengths;
a fluidic cell comprising one or more channels that positions the sample so that at least a portion of the beam is directed at the sample to produce a back reflected beam; and
a spectrometer that analyzes an interference spectrum from the back reflected beam from the sample.

2. The system of claim 1, wherein a spectral bandwidth of the broadband light source is greater than about 10 nanometers.

3. The system of claim 1, wherein the fluidic cell comprises two or more capillary tubes or fluidic channels.

4. The system of claim 3, wherein at least one of the two or more capillary tubes or fluidic channels acts as a reference.

5. The system of claim 3, wherein at least two of the two or more capillary tubes or fluidic channels have different diameters.

6. The system of claim 1, wherein the fluidic cell is configured to undergo a determined temperature change.

7. The system of claim 1, wherein the spectrometer analyzes one or more signals from two or more samples simultaneously.

8. The system of claim 7, wherein one of the two or more samples acts as a reference.

9. The system of claim 1, wherein the spectrometer is a two-dimensional (2-D) spectrometer, or a one-dimensional (1-D) spectrometer.

10. The system of claim 1, wherein the system is used in an in-line process monitoring system.

11. An optical detection system for analyzing a sample, comprising:
a broadband light source that emits a beam comprising a continuous spectrum over a range of wavelengths;
a beam splitter that splits the beam into a first portion and a second portion;
a fluidic cell that positions the sample so that at least a part of the first portion of the beam is directed onto the sample to produce a back reflected beam; and
a spectrometer that analyzes an interference spectrum from the back reflected beam.

12. A method for detecting molecular changes, conformation changes or interactions, comprising:
providing a broadband source that emits a beam comprising a continuous spectrum over a range of wavelengths;
providing a fluidic cell comprising one or more channels;
interacting the sample, introduced into the channels, with at least a portion of the beam and capturing a resultant back reflected beam; and
analyzing an interference spectrum from the back reflected beam using a spectrometer.

13. The method of claim 12, further comprising, splitting the beam in a first portion and a second portion so that the first portion of the beam interacts with the sample to produce a resultant back reflected beam.

14. The method of claim 12, wherein the interference spectrum is analyzed at a frequency in a range from about 1 Hz to about 1 MHz.

15. The method of claim 12, wherein at least two different samples are disposed in the fluidic cell.

16. The method of claim 15, further comprising mixing the two different samples inside the fluidic cell.

17. The method of claim 12, further comprising simultaneously measuring interference spectra of a reference and a sample solution.

18. The method of claim 12, disposing the sample in two or more microfluidic channels in the fluidic cell, wherein the channels have different diameters.

19. The method of claim 12, further comprising applying a reference signal to the interference spectrum to compensate for background interference in the interference spectrum.

20. The method of claim 12, wherein the sample is introduced by introducing a first biochemical species into the channel, and then introducing a second biochemical species in the same channel.

21. The method of claim 12, wherein the sample comprises a liquid.

22. The method of claim 12, comprising analyzing interference spectra from two or more locations in the fluidic cell.

23. The method of claim 12, further comprising, in-line monitoring of the sample.

24. The method of claim 12, further comprising, measuring one or more bio-molecular interactions, protein-protein association or dissociation, multi-protein complex assembly or disassembly, DNA-DNA association or dissociation, molecular aggregation and separation, DNA/RNA-protein association and dissociation, protein or DNA denaturing and multi-protein competition.
